(19) United States
(12) Patent Application Publication
(10) Pub. No.: US 2025/0263195 A1
(43) Pub. Date: Aug. 21, 2025

(54) FLEXIBLE PACKAGING SYSTEM

(71) Applicant: INDUSPAC CALIFORNIA, INC, Newark, CA (US)

(72) Inventor: Jorge Hernan Olazo CRUZ, JR., Dublin, CA (US)

(21) Appl. No.: 19/046,108

(22) Filed: Feb. 5, 2025

Related U.S. Application Data
(60) Provisional application No. 63/553,963, filed on Feb. 15, 2024.

(51) Int. Cl. B65D 5/50; B31B 50/81; B31B 120/10; B31B 120/30; B31B 120/70; B65D 5/42

(52) U.S. Cl. CPC B65D 5/5085; B31B 50/81; B65D 5/4266; B31B 2120/102; B31B 2120/302; B31B 2120/70

(57) ABSTRACT

A packaging assembly including a panel component with a plurality of fold lines formed therein and along which the panel component is foldable, defining a plurality of panel regions. A plurality of impact absorbing molded pulp standoff components are fixed on the panel component, wherein each one of a multiplicity of the panel regions includes at least one of the molded pulp standoff components fixed thereto. The panel component is changeable between a laid flat configuration and a folded configuration, wherein, in the laid flat configuration, the panel regions lie in a substantially common plane and the molded pulp standoff components project in a substantially common direction from the panel component, wherein, in the folded configuration, the panel regions lie in multiple different planes, wherein at least some of the multiple different planes are angularly offset from each other.

### TECHNICAL FIELD

The present application relates generally to packaging assemblies for packaging and shipment of products and, more particularly, to a flexible packaging system adaptable to various products.

### BACKGROUND

Packaging of products to reduce likelihood of product damage during shipping is an important aspect of the ability to ship products. A large variety of existing packaging arrangements are known and are, to some degree, successful. As environmental impact issues become more important to businesses and the general population, the need for the use of recycled or recyclable materials in packaging increases.

Accordingly, new packaging systems and assemblies that more effectively utilize recycled materials are desirable.

### SUMMARY

In one aspect, a packaging assembly includes a panel component including a plurality of fold lines formed therein and along which the panel component is foldable, the fold lines collectively defining a plurality of panel regions, and a plurality of impact absorbing molded pulp standoff components fixed on the panel component, wherein each one of a multiplicity of the panel regions includes at least one of the molded pulp standoff components fixed thereto. The panel component is changeable between a laid flat configuration and a folded configuration, wherein, in the laid flat configuration, the panel regions lie in a substantially common plane and the molded pulp standoff components project in a substantially common direction from the panel component, wherein, in the folded configuration, the panel regions lie in multiple different planes, wherein at least some of the multiple different planes are angularly offset from each other.

In another aspect, a packaged product assembly includes first and second combination panel and standoff component assemblies and a packaged product. The first combination panel and standoff component assembly includes: a first panel component including a plurality of first fold lines formed therein and along which the first panel component is foldable, the first fold lines collectively defining a plurality of first panel regions; a plurality of first impact absorbing molded pulp standoff components fixed on the first panel component, wherein each one of a multiplicity of the first panel regions includes at least one of the first molded pulp standoff components fixed thereto; wherein the first panel component is changeable between a first laid flat configuration and a first folded configuration, wherein, in the first laid flat configuration, the first panel regions lie in a substantially common first plane and the first molded pulp standoff components project in a substantially common first direction from the first panel component, wherein, in the first folded configuration, the first panel regions lie in multiple different planes, wherein at least some of the multiple different planes are angularly offset from each other. The second combination panel and standoff component assembly includes: a second panel component including a plurality of second fold lines formed therein and along which the second panel component is foldable, the second fold lines collectively defining a plurality of second panel regions; a plurality of second impact absorbing molded pulp standoff components fixed on the second panel component, wherein each one of a multiplicity of the second panel regions includes at least one of the second molded pulp standoff components fixed thereto; wherein the second panel component is changeable between a second laid flat configuration and a second folded configuration, wherein, in the second laid flat configuration, the second panel regions lie in a substantially common second plane and the second molded pulp standoff components project in a substantially common second direction from the second panel component, wherein, in the second folded configuration, the second panel regions lie in multiple different planes, wherein at least some of the multiple different planes are angularly offset from each other. The packaged product is engaged (i) on a first side or end by the first combination panel and standoff component assembly in the first folded configuration and (ii) on a second side or end by the second combination panel and standoff component assembly in the second folded configuration.

In another aspect, a method of producing a packaging component for use in packaging a product for shipment, where the method involves: utilizing a panel component that includes a plurality of fold lines formed therein and along which the panel component is foldable, the fold lines collectively defining a plurality of panel regions; utilizing a plurality of impact absorbing molded pulp standoff components; and selectively fixing each of the impact absorbing molded pulp standoff components onto the panel component in positions such that each one of a multiplicity of the panel regions includes at least one of the molded pulp standoff components fixed thereto.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a perspective view of one embodiment of a packaging assembly;

FIGS. 2A-2E show perspective views of molded pulp standoff components of different configurations;

FIGS. 3 and 4 show a laid flat configuration of a combination panel and standoff component assembly;

FIGS. 5A-5D show perspective views of a sequence of packaging a product;

FIGS. 6-9C show another embodiment of a packaging assembly or portions thereof;

FIGS. 10-13B show another embodiment of a packaging assembly or portions thereof; and

FIGS. 14-16B show another embodiment of a packaging assembly or portions thereof.

### DETAILED DESCRIPTION

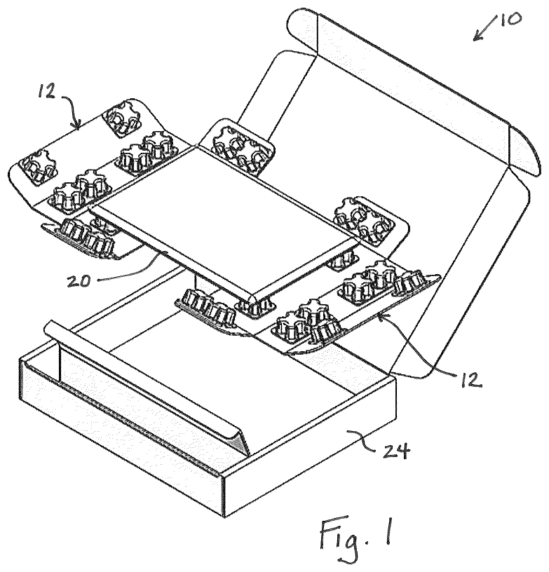

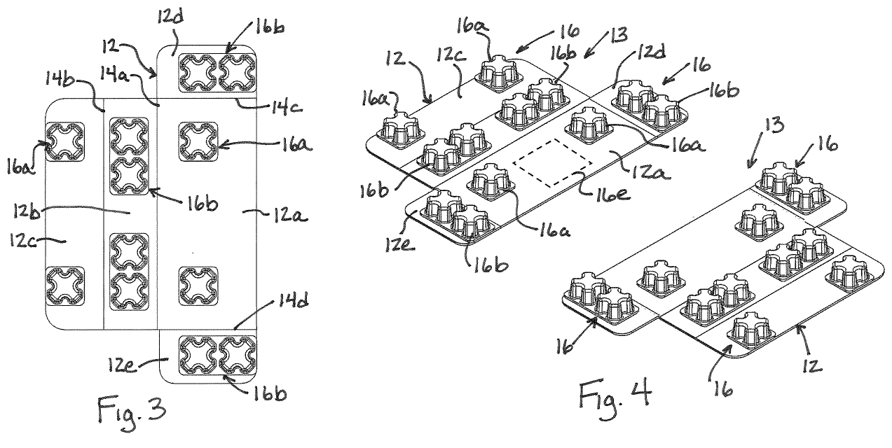

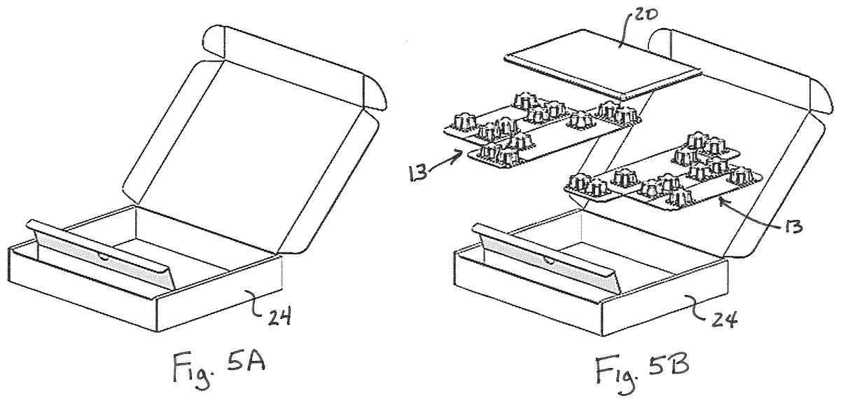

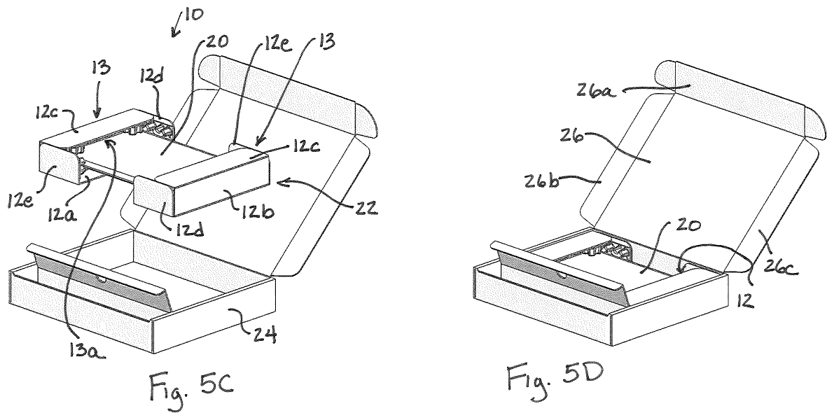

Referring to FIGS. 1-5D, a packaging assembly 10 is shown an includes two like panel components 12, each of which includes a plurality of fold lines 14a-14d formed therein and along which the panel component is foldable. The panel components 12 may be of the corrugated board type, not formed of molded pulp material. By way of example, the fold lines 14a-14d may be compression lines, score lines, perforation lines or other configurations that define lines of weakness in the panel component that facilitate folding. The fold lines 14a-14d collectively define (either alone or in combination with free end edges of the panel component) a plurality of panel regions 12a-12e. A plurality of impact absorbing molded pulp standoff components 16 are fixed on the panel component 12. A multiplicity of the panel regions 12a-12e (here, all of the panel regions) each include at least one of the molded pulp standoff components 16 fixed thereto. The panel components 12 are changeable between a laid flat configuration (e.g., FIG. 4) and a folded configuration (e.g., FIG. 5C). In the laid flat configuration, the panel regions 12a-12e lie in a substantially common plane, and the molded pulp standoff components 16 project in a substantially common direction from the panel component 12. In the folded configuration, the panel regions 12a-12e lie in multiple different planes, and the multiple different planes are angularly offset from each other to facilitate accommodation of a product 20 that is being packaged. Each panel component 12 with molded pulp standoff components 16 fixed thereto may be deemed or termed a combination panel and standoff assembly 13.

In one implementation, each of the molded pulp standoff components 16 is fixed on the panel component, in a respective desired location, by an adhesive. Thus, upon curing of the adhesive, the molded pulp standoff components 16 are not movable to other locations on the panel component. Notably, to further facilitate the folding, none of the molded pulp standoff components 16 are fixed to more than one of the panel regions (i.e., none of the components 16 span over any of the fold lines 14a-14d).

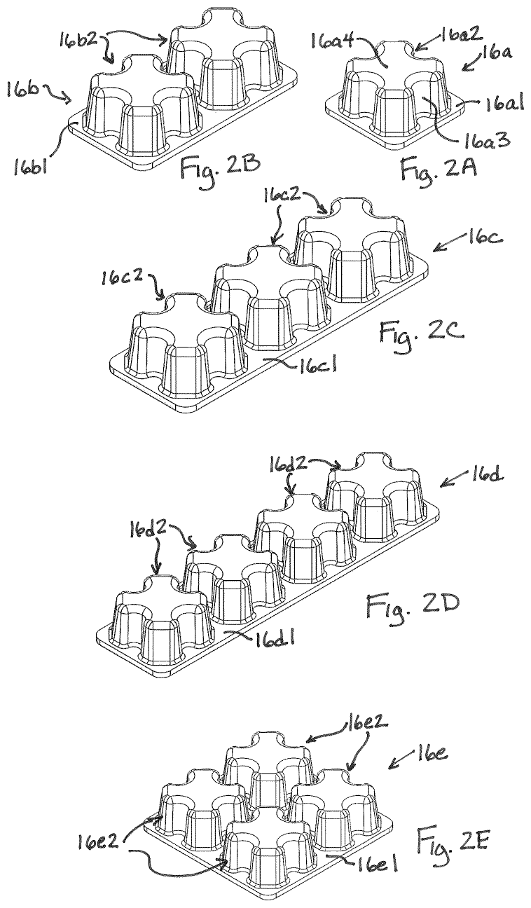

Packaging assemblies of the type described herein may utilize molded pulp standoff components 16 having a variety of different configurations. By way of example, standoff components 16a-16e are shown in FIG. 2. Each standoff component includes a base part 16a1-16e1 and one or more projecting parts 16a2-16e2 projecting therefrom. Here, the base part 16a1-16e1 defines a largest perimeter of the component (in top plan view) and the bottom surface of the base part acts as the surface portion that becomes adhered to the surface of the panel component. The projecting part 16a2-16e2 is hollow. In particular, the upwardly projecting side walls (e.g., 16a3) and the top wall (e.g., 16a4) of each projecting part define a hollow cavity that is open at the bottom side of the base part. Here, each projecting part 16a2-16e2 is of cross-shaped perimeter configuration, and the top wall is substantially planar. However, other configurations are possible.

In respect of the packaging assembly 10, both standoff components 16a and standoff components 16b are fixed to the panel component 12, with standoff components 16a located in each of panel regions 12a and 12c, and standoff components 16b located in each of panel regions 12b, 12d and 12e. In implementations, only a single type of molded pulp standoff component may be used. For example, the illustrated configuration of the combination panel and standoff assembly 13 could be implemented using only standoff components 16a. However, by also utilizing standoff components 16b, the number of steps required to form each combination panel and standoff assembly 13 is reduced (e.g., a single step of fixing of a component 16b to the panel component 12 avoids the need to use two steps to fix two components 16a side-by-side on the panel component 12).

In other embodiments, more than two different configurations of the standoff components 16 might be included on a single panel component 12. For example, a standoff component 16e might also be used, per the dashed line representation in FIG. 4.

As per FIG. 5C, in the packaging assembly 10, in the folded configuration of each individual combination panel and standoff assembly 13, each of the panel regions 12a-12e lies in a different respective plane, with the planes in which panel regions 12a and 12c lie being substantially parallel to each other, the planes in which panel regions 12d and 12e lie being substantially parallel to each other, and with panel region 12b interconnecting panel regions 12a and 12c and lying in a plane that is substantially perpendicular to the planes in which panel regions 12a and 12c lie. In the folded configuration, the standoff components 16a of panel region 12c project toward panel region 12a and the standoff components 16a of panel region 12a project toward panel region 12c. Likewise, the standoff component 16b of panel region 12d projects toward panel region 12e, and the standoff component 16b of panel region 12e projected toward panel region 12d.

Here, all of the molded pulp standoff components 16 of each combination panel and standoff assembly 13 project into a product capture space 13a of the assembly, such that the molded pulp standoff components engage, or are engageable with, respective side or edge regions of the product 20 for fixing or stabilizing the position of the product. Here, the end region of the product 20, which may be, for example a laptop computer or tablet, is fitted into the capture space 13a of an assembly 13 to form a packaged product insert 22 that can then be placed within an interior of a box 24 that is closeable (e.g., via lid 26 with flaps 26a-26c).

Notably, the packaging system is quite versatile and useful for many different products. For example, if the thickness of the product 20 was, for example twice as thick as that shown, the only change needed would be to provide the panel region 12b with a dimension that is slightly larger running in the direction between panel regions 12a and 12c. As die cutting the panel component and creating the fold lines therein is fairly straightforward from a manufacturing perspective, the implementation of a large number of different configurations of combination panel and standoff assemblies for use with different products is facilitated with the described system.

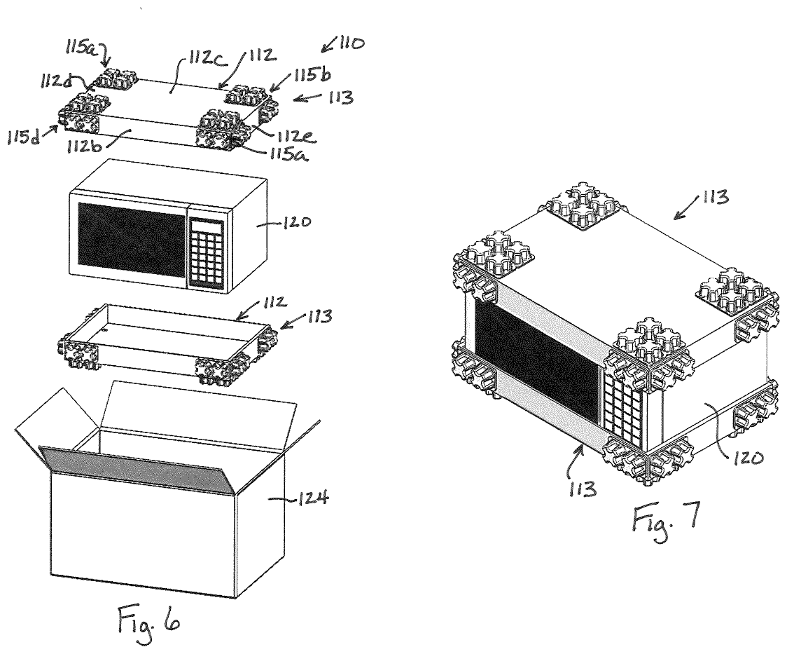

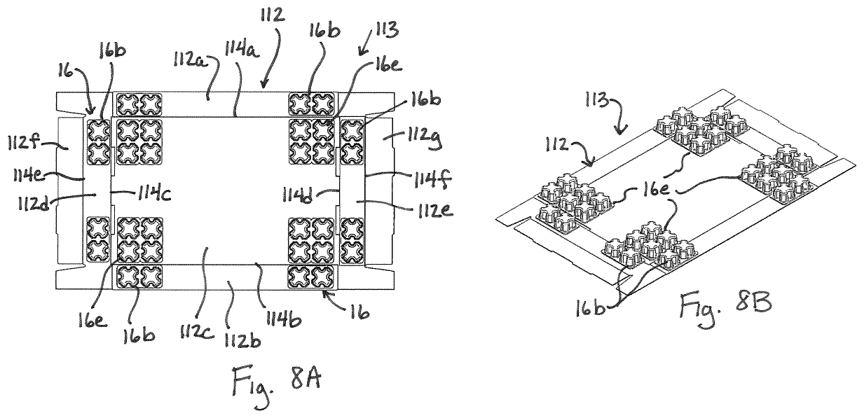

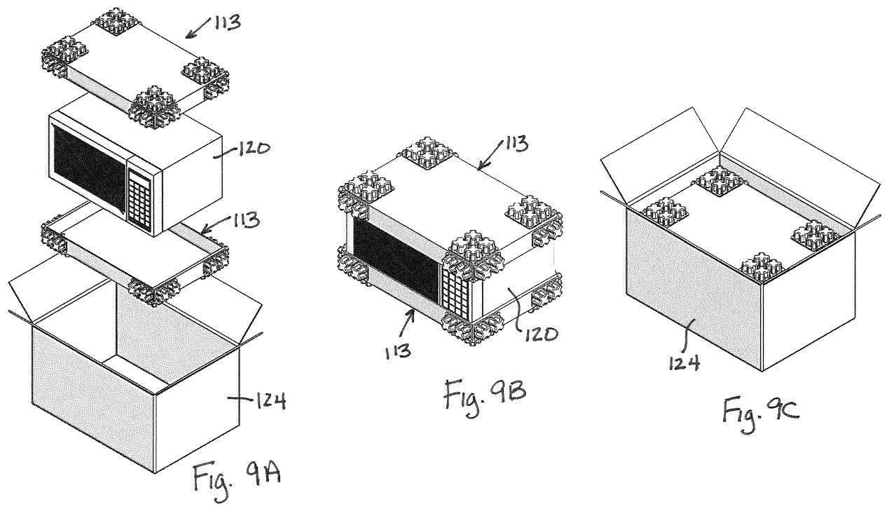

Referring now to FIGS. 6-9C, another embodiment of a packaging assembly 110 for a product 120 (e.g., a microwave oven) is shown and includes two like combination panel and standoff assemblies 113, each formed of a panel component 112, with fold lines 114a-114f to define multiple panel regions 112a-112g and multiple impact absorbing molded pulp standoff components 16. Here, panel regions 112a, 112b, 112d and 112e include molded pulp standoff components 16b, and panel region 112c includes molded pulp standoff components 16e. Panel regions 112f and 112g do not include any standoffs, as these panel regions are folded alongside the panel regions 112d and 112e in the folded configuration that receives the product 120.

Here, in the folded configuration of each of the combination panel and standoff assemblies 113, panel regions 112a, 112c and 112d are oriented relative to each other to define a three-dimensional corner 115a, where molded pulp standoff component 16b on panel region 112a projects outward from the corner 115a in a first direction, molded pulp standoff component 16e on the panel region 112c projects outward from the corner 115a in a second direction that is different from the first direction, and molded pulp standoff component 16b on the panel region 112d projects outward from the corner 115a in a third direction that is different from both the first direction and the second direction. Here, panel region 112c and panel region 112a are directly connected along fold line 114a, wherein panel region 112c and panel region 112d are directly connected along fold line 114c, and panel region 112a and panel region 112d are not directly connected along any fold line. Corners 115b-115d are of a similar configuration to corner 115a.

In the packaging assembly 110, the multi-sided product 120 is captured at top and bottom by respective combination panel and standoff assemblies 113, with the top and bottom corner regions of the product disposed at an interior side of the three-dimensional corners 115a-115d and in engagement with the panel regions forming the corners. Thus, in this arrangement, the distal ends of the molded pulp standoffs 16 do not directly contact the packaged product 120, but instead contact interior surfaces of the panels of the box 124 in which the packaged product is placed for shipping.

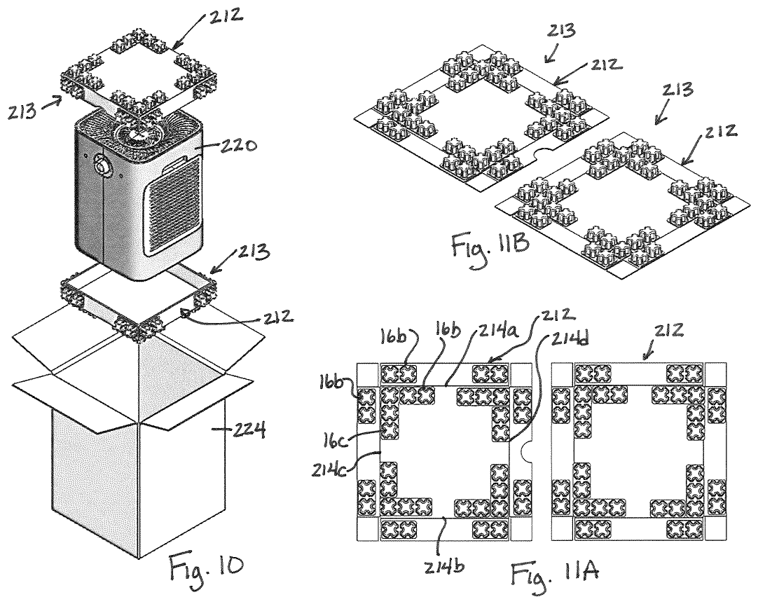

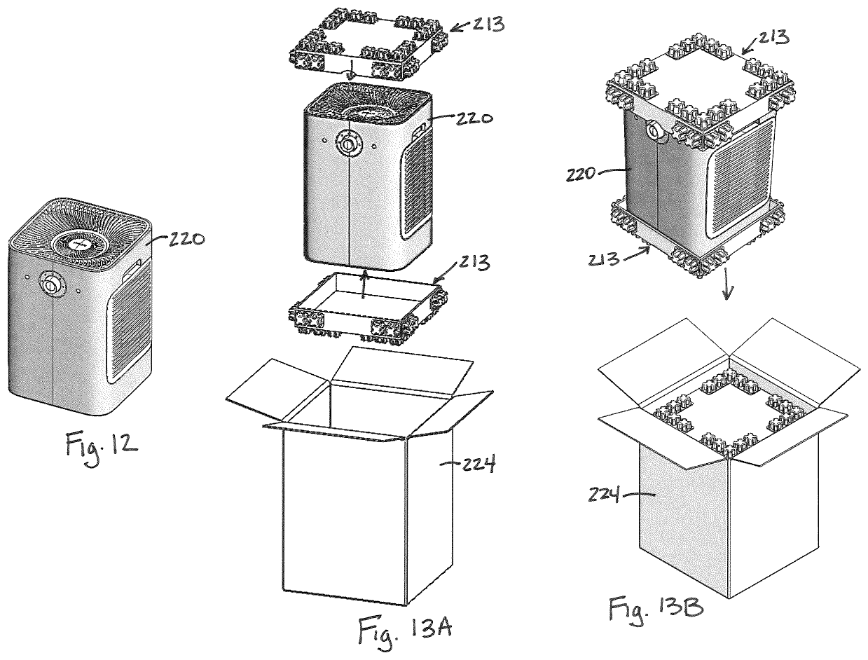

Referring to FIGS. 10-13B, another embodiment of a packaging assembly 210 for a product 220 (e.g., an air purifier) is shown. Here, the panel components 212 (with fold lines 214a-214d) utilize molded pulp standoff components 16b and 16c in the panel regions. This embodiment is similar to packaging assembly 110, in terms of how the corners of the folded combination panel and standoff assemblies 213 are formed and receive the top and bottom corner regions of the product 220 for placement in the box 224 for shipping.

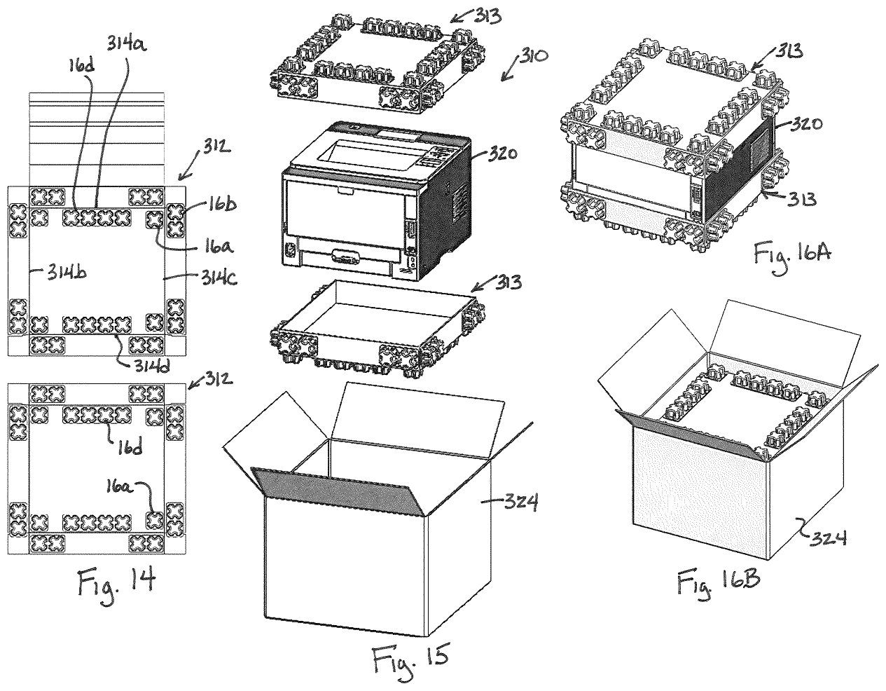

Referring to FIGS. 14-16, another embodiment of a packaging assembly 310 for a product 320 (e.g., a printer) is shown. Here, the panel components 312 (with fold lines 314a-314d) utilize molded pulp standoff components 16a, 16b and 16d in the panel regions. This embodiment is similar to packaging assembly 110, in terms of how the corners of the folded combination panel and standoff assemblies 313 are formed and receive the top and bottom corner regions of the product 320 for placement in the box 324 for shipping.

Notably, the described system provides for an advantageous method of producing a packaging component for use in packaging a product for shipment, where the method involves: utilizing a panel component that includes a plurality of fold lines formed therein and along which the panel component is foldable, the fold lines collectively defining a plurality of panel regions; utilizing a plurality of impact absorbing molded pulp standoff components; and selectively fixing each of the impact absorbing molded pulp standoff components onto the panel component in positions such that each one of a multiplicity of the panel regions includes at least one of the molded pulp standoff components fixed thereto.

In implementations, the impact absorbing molded pulp standoff components are fixed onto the panel by use of an adhesive, and the panel component is a corrugated board panel that is not formed of molded pulp.

In implementations, the panel component is configured such that the panel component is changeable between a laid flat configuration and a folded configuration, wherein, in the laid flat configuration, the panel regions lie in a substantially common plane and the molded pulp standoff components project in a substantially common direction from the panel component, wherein, in the folded configuration, the panel regions lie in multiple different planes, wherein at least some of the multiple different planes are angularly offset from each other.

In implementations, the plurality of impact absorbing molded pulp standoff components comprise a plurality of first molded pulp standoff components having a first configuration and a plurality of second molded pulp standoff components having a second configuration that is different than the first configuration.

In implementations, the plurality of impact absorbing molded pulp standoff components comprise a first molded pulp standoff component having a first configuration, a second molded pulp standoff component having a second configuration that is different than the first configuration and a third molded pulp standoff component having a third configuration that is different than both the first configuration and the second configuration.

It is to be clearly understood that the above description is intended by way of illustration and example only and is not intended to be taken by way of limitation. Variations are possible.

1. A packaging assembly, comprising:
a panel component including a plurality of fold lines formed therein and along which the panel component is foldable, the fold lines collectively defining a plurality of panel regions;
a plurality of impact absorbing molded pulp standoff components fixed on the panel component, wherein each one of a multiplicity of the panel regions includes at least one of the molded pulp standoff components fixed thereto;
wherein the panel component is changeable between a laid flat configuration and a folded configuration, wherein, in the laid flat configuration, the panel regions lie in a substantially common plane and the molded pulp standoff components project in a substantially common direction from the panel component, wherein, in the folded configuration, the panel regions lie in multiple different planes, wherein at least some of the multiple different planes are angularly offset from each other.

2. The packaging assembly of claim 1, wherein the molded pulp standoff components are fixed on the panel component by an adhesive.

3. The packaging assembly of claim 1, wherein the panel component is not formed of molded pulp.

4. The packaging assembly of claim 3, wherein the panel component is a corrugated board panel.

5. The packaging assembly of claim 1, wherein the packaging assembly lacks any molded pulp standoff components that are fixed to more than one of the panel regions.

6. The packaging assembly of claim 1, wherein:
the plurality of panel regions include a first penal region and a second panel region;
the plurality of molded pulp standoff components include a first molded pulp standoff component and a second molded pulp standoff component;
the first molded pulp standoff component located on the first panel region, the second molded pulp standoff component located on the second panel region, wherein the second molded pulp standoff component has a different configuration than the first molded pulp standoff component.

7. The packaging assembly of claim 1, wherein:
the plurality of panel regions include a first penal region and a second panel region;
the plurality of molded pulp standoff components include a first molded pulp standoff component and a second molded pulp standoff component;
in the folded configuration, at least the first panel region lies in a first plane, at least the second panel region lies in a second plane that is spaced apart from and substantially parallel to the first plane, and the first molded pulp standoff component is located on the first panel region and projects toward the second panel region and the second molded pulp standoff component is located on the second panel region and projects toward the first panel region.

8. The packaging assembly of claim 7, wherein the first panel region and the second panel region are connected together by a third panel region, wherein, in the folded configuration, the third panel region runs in a third plane that is substantially perpendicular to both the first plane and the second plane, and a third molded pulp standoff component on the third panel region extends into a space between the first panel region and the second panel region.

9. The packaging assembly of claim 8, further comprising a multi-sided product, wherein the panel component is in the folded configuration and the multi-sided product is captured in a space between the first molded pulp standoff component and the second molded pulp standoff component, and the multi-sided product is also engaged by the third molded pulp standoff component.

10. The packaging assembly of claim 1, wherein:
the plurality of panel regions include a first penal region, a second panel region and a third panel region;
the plurality of molded pulp standoff components include a first molded pulp standoff component, a second molded pulp standoff component and a third molded pulp standoff component;
in the folded configuration, the first, second and third panel regions are oriented relative to each other to define a three-dimensional corner, the first molded pulp standoff component is located on the first panel region and projects outward from the corner in a first direction, the second molded pulp standoff component is located on the second panel region and projects outward from the corner in a second direction that is different from the first direction, and the third molded pulp standoff component is located on the third panel region and projects outward from the corner in a third direction that is different from both the first direction and the second direction.

11. The packaging assembly of claim 10, wherein:
the plurality of fold lines include a first fold line and a second fold line;
the first panel region and the second panel region are directly connected along the first fold line, wherein the first panel region and the third panel region are directly connected along the second fold line, and the second panel region and the third panel region are not directly connected along any fold line.

12. The packaging assembly of claim 11, further comprising a multi-sided product, wherein the panel component is in the folded configuration, wherein a corner region of the multi-sided product is disposed at an interior side of the three-dimensional corner and in engagement with the first panel region, the second panel region and the third panel region.

13. A packaged product assembly, comprising:
a first combination panel and standoff component assembly, comprising:
a first panel component including a plurality of first fold lines formed therein and along which the first panel component is foldable, the first fold lines collectively defining a plurality of first panel regions;
a plurality of first impact absorbing molded pulp standoff components fixed on the first panel component, wherein each one of a multiplicity of the first panel regions includes at least one of the first molded pulp standoff components fixed thereto;
wherein the first panel component is changeable between a first laid flat configuration and a first folded configuration, wherein, in the first laid flat configuration, the first panel regions lie in a substantially common first plane and the first molded pulp standoff components project in a substantially common first direction from the first panel component, wherein, in the first folded configuration, the first panel regions lie in multiple different planes, wherein at least some of the multiple different planes are angularly offset from each other.
a second combination panel and standoff component assembly, comprising:
a second panel component including a plurality of second fold lines formed therein and along which the second panel component is foldable, the second fold lines collectively defining a plurality of second panel regions;
a plurality of second impact absorbing molded pulp standoff components fixed on the second panel component, wherein each one of a multiplicity of the second panel regions includes at least one of the second molded pulp standoff components fixed thereto;
wherein the second panel component is changeable between a second laid flat configuration and a second folded configuration, wherein, in the second laid flat configuration, the second panel regions lie in a substantially common second plane and the second molded pulp standoff components project in a substantially common second direction from the second panel component, wherein, in the second folded configuration, the second panel regions lie in multiple different planes, wherein at least some of the multiple different planes are angularly offset from each other;
a packaged product engaged (i) on a first side or end by the first combination panel and standoff component assembly in the first folded configuration and (ii) on a second side or end by the second combination panel and standoff component assembly in the second folded configuration.

14. The packaged product assembly of claim 13, further comprising:
a box;
wherein the packaged product, first combination panel and standoff component assembly and second combination panel and standoff component assembly are contained within the box.

15. A method of producing a packaging component for use in packaging a product for shipment, the method comprising:
utilizing a panel component that includes a plurality of fold lines formed therein and along which the panel component is foldable, the fold lines collectively defining a plurality of panel regions;
utilizing a plurality of impact absorbing molded pulp standoff components;
selectively fixing each of the impact absorbing molded pulp standoff components onto the panel component in positions such that each one of a multiplicity of the panel regions includes at least one of the molded pulp standoff components fixed thereto.

16. The method of claim 15, wherein impact absorbing molded pulp standoff components are fixed onto the panel by use of an adhesive.

17. The method of claim 15, wherein the panel component is a corrugated board panel that is not formed of molded pulp.

18. The method of claim 15, wherein the panel component is configured such that the panel component is changeable between a laid flat configuration and a folded configuration, wherein, in the laid flat configuration, the panel regions lie in a substantially common plane and the molded pulp standoff components project in a substantially common direction from the panel component, wherein, in the folded configuration, the panel regions lie in multiple different planes, wherein at least some of the multiple different planes are angularly offset from each other.

19. The method of claim 15, wherein the plurality of impact absorbing molded pulp standoff components comprise a plurality of first molded pulp standoff components having a first configuration and a plurality of second molded pulp standoff components having a second configuration that is different than the first configuration.

20. The method of claim 15, wherein the plurality of impact absorbing molded pulp standoff components comprise a first molded pulp standoff component having a first configuration, a second molded pulp standoff component having a second configuration that is different than the first configuration and a third molded pulp standoff component having a third configuration that is different than both the first configuration and the second configuration.
